(19) United States
(12) Patent Application Publication
(10) Pub. No.: US 2026/0233434 A1
(43) Pub. Date: Aug. 13, 2026

(54) RESIN RECOVERY METHOD

(71) Applicant: HONDA MOTOR CO., LTD., Tokyo (JP)

(72) Inventors: Haruki CHIBA, Saitama (JP); Yasushi TERASAKA, Saitama (JP)

(21) Appl. No.: 19/424,069

(22) Filed: Dec. 17, 2025

(30) Foreign Application Priority Data
Jan. 24, 2025 (JP) 2025-010232

(51) Int. Cl. B29B 17/02; B29B 9/06

(52) U.S. Cl. CPC B29B 17/02; B29B 9/065; B29B 2017/0293

(57) ABSTRACT

A method for recovering resin from a fiber-reinforced resin provides a resin recovery method including the steps of: dissolving a resin contained in the fiber-reinforced resin in ethylene glycol, solid-liquid separating into a solution in which the resin is dissolved in ethylene glycol, and fiber, heating concentrating the solution to obtain a concentrated liquid, and cutting the concentrated liquid in water.

This application is based on and claims the benefit of priority from Japanese Patent Application No. 2025-010232, filed on 24 January 2025, the content of which is incorporated herein by reference.

### BACKGROUND OF THE INVENTION

### FIELD OF THE INVENTION

The present invention relates to a method for recovering resin from a fiber reinforced resin.

### Related Art

In recent years, efforts directed at a significant reduction in the generation of waste materials are becoming more active, by the prevention or reduction of waste generation, recycling and reuse. Towards this realization, research and development is being carried out into recycling of waste plastic materials.

Japanese Unexamined Patent Application, Publication No. 2019-104861 discloses a recycling method of fiber-reinforced resin composite materials made by mixing fibers into the resin to increase the strength. The recycling method for fiber- reinforced resin composite materials separates the fiber from waste material of fiber-reinforced resin composite materials by a solvent in which the resin has high solubility, and separates and recovers the solvent and resin from the solution after fiber separation.

Patent Document 1: Japanese Unexamined Patent Application, Publication No. 2019-104861

### SUMMARY OF THE INVENTION

However, in the recycling method of fiber-reinforced resin composite materials disclosed in Japanese Unexamined Patent Application, Publication No. 2019-104861, when using ethylene glycol as the solvent, the residual amount of ethylene glycol in the recovered resin becomes greater.

The present invention has an object of providing a resin recovery method capable of reducing the residual amount of ethylene glycol therein.

(1) A resin recovery method includes the steps of: dissolving a resin contained in the fiber-reinforced resin into ethylene glycol; solid-liquid separating into a solution in which the resin is dissolved in ethylene glycol, and fiber; heating concentrating the solution to obtain a concentrated liquid; and cutting the concentrated liquid in water.

(2) In the resin recovery method as described in (1), the resin contained in the concentrated liquid to be cut in the water is melted.

(3) In the resin recovery method as described in (1) or (2), a concentration kettle is used upon heating concentrating the solution, an underwater cutting-type pelletizer is used upon cutting the concentrated liquid in water, and the concentration kettle and the pelletizer are connected in an airtight manner.

(4) In the resin recovery method as described in any one of (1) to (3), upon heating concentration of the solution, the solution is heating concentrated while stirring to obtain a first concentrated liquid, followed by heating concentrating the first concentrated liquid while stirring to obtain a second concentrated liquid, and a stirring power for stirring the first concentrated liquid is greater than a stirring power for stirring the solution.

(5) In the resin recovery method as described in (4), the first concentrated liquid has an ethylene glycol concentration of 8% by mass or more and 23% by mass or less, and the second concentrated liquid has an ethylene glycol concentration of 2% by mass or more and 5% by mass or less.

According to the present invention, it is possible to provide a resin recovery method capable of reducing the residual amount of ethylene glycol therein.

### DETAILED DESCRIPTION OF THE INVENTION

Hereinafter, an embodiment of the present invention will be described.

A resin recovery method according to the present embodiment is a method for recovering resin from a fiber-reinforced resin. The fiber-reinforced resin is not particularly limited; however, the crushed material of intake manifolds can be exemplified. The fibers constituting the fiber-reinforced resin are not particularly limited; however, glass fibers and carbon fibers can be exemplified. The resin constituting the fiber-reinforced resin is not particularly limited so long as able to dissolve in ethylene glycol; however, polyamides such as nylon 6 and nylon 66 can be exemplified.

Hereinafter, each step of the resin recovery method according to the present embodiment will be described.

### (Dissolution Step)

First, the resin contained in the fiber-reinforced resin is dissolved in ethylene glycol. The method of dissolving the resin contained in the fiber-reinforced resin in ethylene glycol is not particularly limited; however, a method which mixes the fiber-reinforced resin and ethylene glycol, then heat refluxes can be exemplified. At this time, the heat refluxing temperature is not particularly limited so long as being a temperature less than the boiling point of ethylene glycol; however, it is 150°C or more and 170°C or less, for example.

### Solid-liquid Separation Step

It is solid-liquid separated into a solution in which the resin is dissolved in ethylene glycol, and fibers. The method of solid-liquid separating is not particularly limited; however, a method of filtering with a filter, and a method of centrifuging can be exemplified.

### Heating Concentration Step

A concentrated liquid is obtained by heating concentration of the solution. The concentration of ethylene glycol in the concentrated liquid is not particularly limited; however, it is 2% by mass or more and 5% by more or less, for example. At this time, the heating concentration temperature is preferably a temperature at which the resin contained in the concentrated liquid melts. As described later, heat loss is suppressed in the case of the resin contained in the concentrated liquid to be cut being melted. Upon heating concentration of the solution, it is preferable to stir the solution. The heating concentration time is thereby shortened. In addition, upon heating concentration of the solution, it is preferable to reduce pressure. The heating concentration time is thereby shortened. At this time, the degree of pressure reduction is not particularly limited; however, it is 20 kPa or more and 100 kPa or less, for example. Upon heating concentration of the solution, a concentration kettle is preferably used. The recovery rate of ethylene glycol contained in the solution thereby increases.

Upon heating concentration of the solution, after obtaining a first concentrated liquid by heating concentration of the solution while stirring, the first concentrated liquid is heating concentrated while stirring to obtain a second concentrated liquid, and the stirring power for stirring the first concentrated liquid is preferably greater than the stirring power for stirring the solution. Explosive boiling upon cutting the second concentrated liquid in water is thereby suppressed. At this time, the concentration of ethylene glycol in the first concentrated liquid is preferably 8% by mass or more and 23% by mass or less, and the concentration of ethylene glycol in the second concentrated liquid is preferably 2% by mass or more and 5% by mass or less.

It should be noted that the heating concentration temperature upon obtaining the second concentrated liquid is not particularly limited; however, it is 150°C or more and 300°C or less, for example. The degree of pressure reduction upon obtaining the second concentrated liquid is not particularly limited; however, it is 80 kPa or more and 100 kPa or less, for example. In addition, the heating concentration temperature upon obtaining the first concentrated liquid is not particularly limited; however, it is 150°C or more and 300°C or less, for example. The degree of pressure reduction upon obtaining the first concentrated liquid is not particularly limited; however, it is 20 kPa or more and less than 80 kPa, for example.

Since the second concentrated liquid has higher viscosity than the first concentrated liquid, a mixer blade for low viscosity (for example, Maxblend blade) is preferably used as necessary upon obtaining the first concentrated liquid, and a mixer blade for high viscosity (for example, helical ribbon blade) is preferably used upon obtaining the second concentrated liquid. The manufacturing stability upon heating concentration of the solution to produce a concentrated liquid thereby improves.

### Cutting Step

The concentrated liquid is cut in water to obtain recycled resin. Since the ethylene glycol contained in the concentrated liquid elutes in water, the residual amount of ethylene glycol in the recycled resin is thereby reduced. The temperature of the water is not particularly limited so long as able to cut the concentrated liquid in water; however, it is 50°C or more and 60°C or less, for example. Upon cutting the concentrated liquid in water, an underwater cutting-type pelletizer is preferably used, and the concentration kettle and pelletizer are preferably connected in an airtight manner. The recovery rate of ethylene glycol contained in the concentrated liquid thereby increases.

The residual amount of ethylene glycol in the recycled resin is not particularly limited; however, it is 1% by mass or less, for example. Although the form of the recycled resin is not particularly limited, pellets can be exemplified.

The resin contained in the concentrated liquid to cut in water is preferably melted. Since the water temperature near the concentrated liquid thereby becomes higher, the ethylene glycol contained in the concentrated liquid will tend to elute. It should be noted that the temperature of the concentrated liquid to be cut in water is not particularly limited; however, it is 150°C or more and 300°C or less, for example.

It should be noted that, when treating the recycled resin in subcritical water by a known method, monomers are recovered. At this time, if the residual amount of ethylene glycol in the recycled resin is not reduced, the yield of monomer will decline.

Although an embodiment of the present invention has been described above, the present invention is not limited to the above embodiment, and the above embodiment may be modified as appropriate within the scope of the gist of the present invention.

### EXAMPLES

Although examples of the present invention will be described below, the present invention is not to be limited to the examples.

### Example 1

### Dissolution Step

The waste material of glass fiber-reinforced nylon 6 (crushed material of intake manifolds) and ethylene glycol are mixed so as to make the mass ratio of nylon to ethylene glycol of 1:3 (50 kg: 150 kg), followed by heating reflux for 1 hour at 170°C, whereby the nylon 6 was dissolved in ethylene glycol to obtain a liquid mixture. Herein, the glass fiber-reinforced nylon 6 has a mass ratio of nylon 6 to glass fiber of 70:30.

### Solid-liquid Separation Step

The liquid mixture having a liquid temperature of 170°C was filtered with a filter having an opening size of 20 μm to solid-liquid separate into an ethylene glycol solution of nylon 6, and glass fibers.

### Heating Concentration Step

After feeding 200 kg of the ethylene glycol solution of nylon 6 to a first concentration kettle, the ethylene glycol was distilled until the concentration of ethylene glycol reached 8.0% by mass, while further stirring with a Maxblend blade under conditions of 170°C temperature and 20 kPa reduced pressure, thereby obtaining 54 kg of the first concentrated liquid. At this time, the temperature increased to reach 280°C, accompanying the progression of the concentration of the ethylene glycol solution of nylon 6. Herein, 280°C is a temperature exceeding the melting temperature, which is no more than the melting point (220°C) of nylon 6.

After feeding 54 kg of the first concentrated liquid to a second concentration kettle, the ethylene glycol was distilled until the concentration of ethylene glycol reached 3.0% by mass, while further stirring with a helical ribbon blade under conditions of 280°C temperature and 80 kPa reduced pressure, thereby obtaining 51.5 kg of the second concentrated liquid. At this time, the stirring power by the helical ribbon blade was set to be greater than the stirring power by the Maxblend blade. In addition, the nylon 6 contained in the second concentrated liquid had melted.

### Cutting Step

Using a gear pump, the second concentrated liquid was supplied to an underwater cutting-type pelletizer under the following conditions to cut the second concentrated liquid and obtain recycled nylon 6 pellets. At this time, the nylon 6 contained in the second concentrated liquid to be cut was melted. In addition, the recycled nylon 6 pellets had a residual amount of ethylene glycol of 1.0% by mass or less, and a diameter of 3.2 mm. In addition, there was no explosive boiling upon cutting the second concentrated liquid.

Feed rate of second concentrated liquid: 10 kg/h

Temperature of die heater: 280°C

Rotation speed of rotary blade: 3000 rpm

What is claimed is:

1. A resin recovery method for recovering resin from a fiber-reinforced resin, the method comprising the steps of:
dissolving a resin contained in the fiber-reinforced resin into ethylene glycol;
solid-liquid separating into a solution in which the resin is dissolved in ethylene glycol, and fiber;
heating concentrating the solution to obtain a concentrated liquid; and
cutting the concentrated liquid in water.

2. The resin recovery method according to claim 1, wherein the resin contained in the concentrated liquid to be cut in the water is melted.

3. The resin recovery method according to claim 1, wherein
a concentration kettle is used upon heating concentrating the solution,
an underwater cutting-type pelletizer is used upon cutting the concentrated liquid in water, and
the concentration kettle and the pelletizer are connected in an airtight manner.

4. The resin recovery method according to claim 1,
wherein, upon heating concentration of the solution, the solution is heating concentrated while stirring to obtain a first concentrated liquid, followed by heating concentrating the first concentrated liquid while stirring to obtain a second concentrated liquid, and
wherein a stirring power for stirring the first concentrated liquid is greater than a stirring power for stirring the solution.

5. The resin recovery method according to claim 4,
wherein the first concentrated liquid has an ethylene glycol concentration of 8% by mass or more and 23% by mass or less, and
wherein the second concentrated liquid has an ethylene glycol concentration of 2% by mass or more and 5% by mass or less.
